(19) United States
(12) Patent Application Publication
(10) Pub. No.: US 2021/0150840 A1
(43) Pub. Date: May 20, 2021

(54) APPARATUS AND METHODS OF COLLABORATIVE DECISION MAKING

(71) Applicant: Ashley Marie Roethlisberger, Dallas, TX (US)

(72) Inventor: Ashley Marie Roethlisberger, Dallas, TX (US)

(21) Appl. No.: 17/098,792

(22) Filed: Nov. 16, 2020

Related U.S. Application Data
(60) Provisional application No. 62/936,109, filed on Nov. 15, 2019.

(51) Int. Cl. G07C 13/00; G06N 5/02

(52) U.S. Cl. CPC G07C 13/00; G06F 3/0482; G06N 5/02

(57) ABSTRACT

Methods and devices for facilitating collaborative decision making between two decision makers that includes generating a set of potential decisions and then during a time span, periodically, eliminating a number of potential decisions from the set of potential decisions, until a specified number of potential decisions remain, each of the two decision makers selects a set of decisions to obtain a first set s₁ and a second set s₂ of potential decisions, then determining a basis for a decision by generating an intersection of set s₁ and set s₂; and make a decision by selecting the decision from the basis.

### CROSS REFERENCE

This application claims the benefit under 35 U.S.C. § 119(e) of the earlier filing date of U.S. Provisional Patent Application No. 62/936,109 filed on Nov. 15, 2019, the disclosure of which is incorporated by reference herein.

### FIELD

This disclosure is generally related to devices, methods, and techniques for facilitating consensus through collaborative decision making.

### BACKGROUND

Various techniques have been developed to achieve consensus among multiple decision makers. A variety of exemplary decision making processes are known, for example in force field analysis, parameters weighing in favor of a particular decision are collected, assigned weights based on their criticality to decision making, and an algorithm is applied to account for the weighted parameters, and based on that algorithm a decision is achieved. In a Pugh analysis, a force field analysis is modified to weigh each parameter relative to a specific standard, where a parameter that improves over a standard is assigned a positive weight value and a parameter that detracts from the standard is assigned a negative weight value. In DACI analysis, decision makers are assigned roles, and each decision maker contributes parameters which are weighed based on the role of the decision maker. In a multi-voting analysis, each decision maker is assigned one or more votes, and is able to vote one or more times for one or more choices. Decision makers may be independent algorithms, competing automated systems, or humans engaged in critical decision making.

### BRIEF DESCRIPTION OF THE DRAWINGS

FIG. 1 illustrates functional flow diagram of a process in accordance with this disclosure.

FIG. 2 illustrates aspects of a system in accordance with this disclosure.

FIG. 3 illustrates aspects of a display device in accordance with this disclosure.

FIG. 4 illustrates aspects of a display device in accordance with this disclosure.

FIG. 5 illustrates aspects of a display device in accordance with this disclosure.

FIG. 6 illustrates aspects of a display device and techniques in accordance with this disclosure.

FIG. 7 illustrates aspects of a display device and techniques in accordance with this disclosure.

FIG. 8 illustrates aspects of a display device and techniques in accordance with this disclosure.

FIG. 9 illustrates aspects of a display device and techniques in accordance with this disclosure.

FIG. 10 illustrates aspects of a display device and techniques in accordance with this disclosure.

FIG. 11 illustrates aspects of a display device in accordance with this disclosure.

FIG. 12 illustrates aspects of a fastening device in accordance with this disclosure.

FIG. 13 is a flow chart of a process in accordance with this disclosure.

FIGS. 14a and 14b illustrate aspects of a display in accordance with this disclosure.

FIG. 15 illustrate aspects of a display in accordance with this disclosure.

FIGS. 16-17 illustrate aspects of a keepsake box in accordance with this disclosure.

### DETAILED DESCRIPTION

Disclosed are one or more embodiments that incorporate features of this invention. The disclosed embodiment(s) merely exemplify the invention. The scope of the invention is not limited to the disclosed embodiments. Rather, the invention is defined by the claims hereto.

While various competitive decision making techniques are known, as briefly summarized in the background section above, these techniques fail when (1) the specific parameters for or against a decision are unknown, and/or (2) there are only two decision makers in which case voting power is equal. For example, in some decision making scenarios, the reasons a decision maker determines one outcome is desired relative to another outcome are unknown to the decision maker itself (or himself or herself), because the underlying parameters affecting a decision makers decision making are unknown to the decision maker. Humans, for example, often settle on choices without a true understanding of the decision making logic employed to reach such a decision, and often times humans are predisposed to certain decisions without considering alternatives due to an recognized underlying logic overpowering rational decision making. In the context of decision making machines, recent developments in algorithms, for example, have led to computers configured as artificial intelligences that are capable of making decisions in real time without the ability of algorithm designers to explain how the algorithm arrived at a particular decision. Where an algorithms' designer, e.g., a designer of a deep learning neural network, is unable to explain how a computer makes a choice, it cannot be expected that the computer would be able to explain how it made such a choice.

Disclosed herein are techniques and apparatus for facilitating reaching consensus during collaborative decision making between two entities, which may be, for example, a computer based decision maker, a human, or some interaction between a computer based decision maker and a human.

In an exemplary embodiment, each of two decision makers contributes a number N of choices. An additional choice is selected, either randomly, or by one of the two decision makers, in order to obtain an odd number of D=n+1 total choices, where n=2*N. A display is created displaying all D=n+1 choices, each choice a potential decision. This display is displayed or maintained in a location that places the display within a span of attention of each decision maker at least periodically over a span of time T, with a period p. During each period p each user considers the n choices, and at the end of, or during, each period p, each user is empowered to remove a number a of choices (in some embodiments, each user is empowered to remove a=1 choices, in other embodiments, each decision maker is empowered to remove multiple, i.e. a>1, choices during a single period). Because a decision makers' decision making logic changes over time, and in many decision makers decision making can become quite fluid, by requiring each decision maker to consider the remainder of the D choices, at least once during each period p, the act of considering each of the remaining choices of the D total choices alters the decision maker's underlying decision making parameters and logic, without the knowledge or awareness of the decision maker that this is happening. In this way, two or more decision makers may unknowingly trend towards agreement.

After a set number of periods p, the span of time T expires, and a number (n−aT/p)+1 of decisions remain, where dᵣ=aT/p is the number of removed decisions. Each decision maker is then required to select a sets of remaining decisions, e.g., s1 and s2. In a case where there are two decision makers, each decision maker will select ((n−aT/p)/2)+1 remaining potential decisions, such that each set, e.g., s1 and s2 includes ((n−aT/p)/2)+1 potential decisions guaranteeing that the intersection of s1 and s2 is a non-empty set. The intersection i of sets s1 and s2 is obtained and becomes the decision basis. Having obtained the decision basis, any number of techniques can be employed to generate a consensus decision. For example, one of the decision makers may select any one of the choices from a decision basis, or alternatively a choice may be selected at random from the decision basis. In some cases, decision basis formed by intersection i will include only one potential decision, which by default will be the decision.

In one exemplary embodiment, two decision makers will select a name for a person, e.g., a newly born baby to be. Fifty on choices of baby names, i.e., N=25 choices, n=50 choices, are received and displayed to both decision makers at least once daily, p=1 day, for 46 days, i.e., T=46 days. Each day, p, one of the two decision makers is empowered to remove a choice of a baby name from the remaining baby names. Such a removed name may be retained in a removed name storage for later retrieval as necessary. After the span of time, T, of 46 days, i.e., 46 periods p, a set S of five baby names remain, i.e., five potential decisions, such that S={d1, d2, d3, d4, d5}, each dₙ a potential baby name. Subsequently, each person secretly selects a set sₙ of decisions to obtain separate sets of decisions, e.g., s1={d1, d4, d5} and s2={d2, d3, d4}. Based on these two separate sets of decisions, the intersection of these two sets, e.g., s1 and s2, is generated, and the generated intersection i forms the decision basis, e.g., i={d4}. In embodiments, a variety of mechanisms can be employed to select a final name from the decision basis if the basis exceeds one member. If the decision basis i only includes one member, that member is the consensus decision. If there are multiple names, one decision maker may be selected at random to select the final name from the decision basis. Or, a decision may be made at random by randomly selecting a name from the decision basis.

In some embodiments, after span of time T has passed, and a set S of remaining names is determined, a variety of alternative techniques may be introduced, for example, to create additional variation in the process. For example, at a final additional period, each decision maker may revive one decision that was removed to add to the set S of remaining names. In another alternative, a randomly selected decision maker may unilaterally strike one or more names.

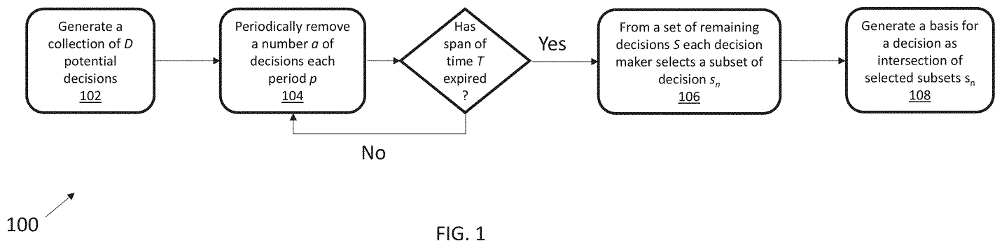

These techniques are further described below in references to FIGS. 1-14.

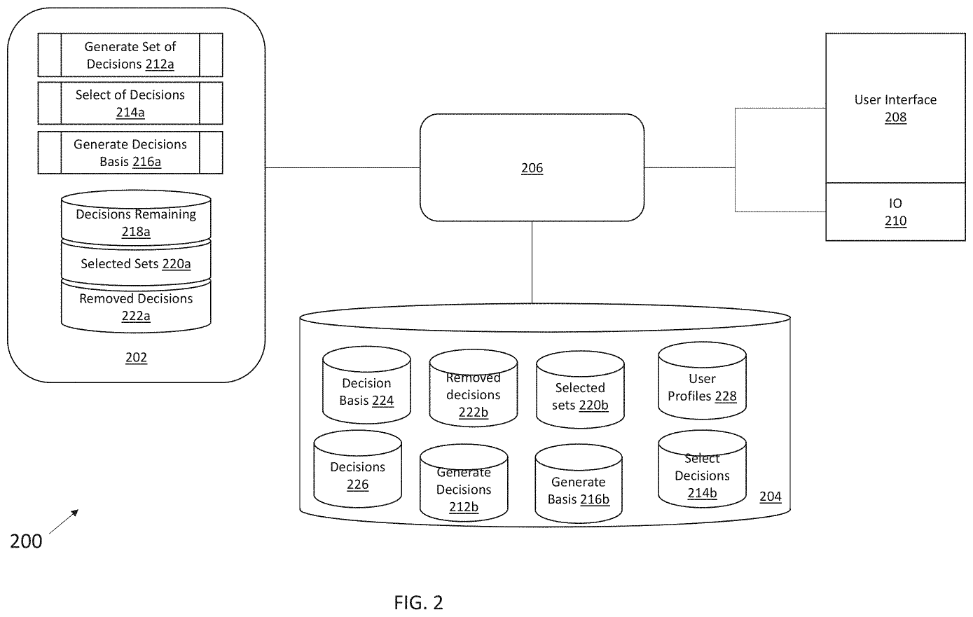

FIG. 1 illustrates a general process 100 in accordance with this disclosure. This process may be performed using a computer as discussed further in reference to FIG. 2 below, or it may be performed with the aid of a physical display and other devices for facilitating collaborative decision making as explained herein. Generally, the process unfolds as follow. In a first phase 102, a collection, denoted by D, of potential decisions is generated or otherwise obtained. These decisions may be culled from a catalog of decisions or from a set of all possible decisions associated with a particular endeavor. In the example embodiment discussed above, the collection of names D included a set of 50 baby names. In alternative examples, collection D may be a collection of potential pet names, a collection of potential travel destinations, or a collection of potential new hires for a business. Generally, the systems and methods described herein are effective for facilitating any sort of collaborative decision making involving selection of one, or a limited number of, options from a large collection of potential decisions. Decision makers may be individuals or groups of individuals, or as described above, one or more autonomous decision makers. In the example discussed above, for example, a set of decisions may be selected according to any suitable means from a catalog of baby names.

Subsequently, during a culling period 104, the decision makers periodically select and remove disfavored decisions over a span of time T In this way during each period, p, one or more decision makers considers the remaining decisions and selects one for removal. The span of time and regular periodic consideration of each of the remaining potential decisions is critical to facilitating collaborative decision making for the reasons described above (i.e., that one's underlying logic may shift or change overtime, such that different decision makers decision making is encouraged to converge overtime by periodic consideration of the remaining decisions). In one example, a span of time may be a set number of days, e.g., T=46 days, and a period may be daily, i.e., p=1 day. The time span T may, however, be shorted or extended depending on the length of time available in which to make a decision. In some cases, T may be measured in hours rather than days, and likewise period p may be longer or short depending on the length of time span T. As will be appreciated upon reading this disclosure in full, T and p will also depend the number of potential decisions in the set D of potential decisions and based on the number a of decisions negated, or removed, during each period, p, by each respective decision makers. Thus, for example, in one example, during a period, p, the number of decisions removed, a, is one, such that each period one decision maker removes one potential decision. In another example, the number of decisions removed, a, is 2, such that during each period each of two decision makers removes one decision. Alternatively, one decision maker may remove two decisions during a period, and during a subsequent period a second decision maker may remove two decisions and so on. In any case, this culling period 104 continues until the span of time, T, expires.

It will be appreciated that the number of potential decisions (i.e., the number of members of set D) may be any number, provided that the time span, T, over which decision making will occur, the period, p, in which potential decisions are considered, the number of decision makers, the size of the set, S, of remaining decisions, and the size of the selected subsets sₙ are tailored appropriately. How to select these parameters will be well understood upon a full reading of this disclosure and the appended claims.

After the span of time, T, has lapsed a set S of remaining potential decisions is left during a selection phase 106. It will be appreciated upon reading this disclosure in full that the number of members of set S will depend on the parameters T, D, p, a, and the number of decision makers. In an exemplary embodiment, the number of decision makers is two, and T=46, D=51, p=1, and a=1, such that S has five members. During selection period 106, each decision maker selects a minimum number of decisions from S to ensure that there is at least an overlap of one decision in the selected decisions of each decision maker. For example, where S has five members, each decision maker selects three potential decisions to form subsets sₙ of three selected decisions. In an alternative embodiment, set S includes six members, in which case each subset sₙ would include four members to ensure an overlap. In preferred embodiments, the remainder set S is an odd number in order to minimize both the number of members of each subset sₙ as well as the size of the overlap, as this has been found to further facilitate decision makers ability to reach harmonious consensus as to a final decision. During the selection phase 106, in some embodiments, each decision maker secretly selects a number of potential decisions from the remainder set S of potential decisions. In an alternative embodiment, the selection phase 106 may be performed openly with each decision maker observing the other member's selection.

In a final phase 108, the decision basis is generated, or otherwise obtained, by determining an intersection i of each decision makers selected subsets sₙ. This intersection represents the overlap of potential decisions selected by each decision maker. In other words, this intersection includes only those choices that each decision maker selected as a member of each decision makers selected subset. For example, if in phase 106 of an embodiment including two decision makers, a first decision maker selected a subset s₁={d1, d4, d5} and a second decision maker selects a subset s₂={d2, d3, d4}, the decision basis formed by the intersection i=s1∩s2={d4}. From this basis, a decision is selected. In this case, with i including a single member, the basis forms the decision. In alternative cases, the decision basis may include two or more potential decisions from which the decision makers may choose collaboratively knowing that each decision maker had selected each member of the decision basis as a potential final decision. Accordingly, decision making has been facilitated. In some embodiments, the members of a respective decision maker's selected subset sₙ are referred to as that member's faves, or favorites.

In some embodiments, during the selection period 106, for additional variation, each decision maker may selected a previously removed, or negated, potential decision and return it to the set of remaining potential decisions S for consideration in forming each decision maker's selected subset sₙ. In alternative embodiments, this saved decision may be identified any time during the culling period 104 or the selection period 106.

FIG. 2 illustrate aspects of a system 200 for facilitating collaborative decision making. System 200 includes a processor 206 operatively coupled to memories 202 and 204, where memory 202 is a transitory memory, such as a computer random access memory, while memory 204 is a non-transitory memory, such as a hard drive. In embodiments, processor 206 reads instructions from non-transitory memory 204 and loads them into transitory memory 202 for processing. Such instructions may include computer readable instructions for generating a set of potential decisions 212, instructions for selecting decisions 214, and instructions for displaying decision 216. In embodiments, instructions for generating a set of potential decisions 212, e.g., during a first phase 102, may cause the processor to randomly generate a set of potential decisions, e.g., by reading potential decisions from a data store of a collection of potential decisions 226 (e.g., a catalog of pet names, or baby names, or travel destinations, or the like). Alternatively, instructions for generating set of potential decisions 212 may cause the process to request from a user via a user interface, e.g., 208, to supply decisions. Alternatively, instructions 212 may be configured to cause the processor to present a catalog of potential decisions 226 to one or more users who may navigate the catalog and select a set D of potential decisions. Instructions 212 may then cause the set D of potential decisions to be stored in memory for access during subsequent phases (e.g., phases 104, 106 discussed above).

Computer instructions for selecting decisions 214 may be read from memory 202 to cause the potential decisions remaining 218 to be displayed on a user interface, e.g., 208, for consideration by a user. Instructions 214 may also provide for selection functionality thereby allowing a user to input selection, e.g., via I/O device 210, in order to make selections from the displayed remaining selections 218. IO device 210 may for example be a computer mouse, a computer keyboard, or a touch screen or a combination of such devices as one will appreciate. Instructions for selecting decisions 214 may cause the processor to operate differently depending on which phase (e.g., 104 or 106 described above) the process is currently in. During a culling phase, instructions 214 may be configured to allow a user to input selections via IO 210 thereby removing or negating potential decisions from the set of decisions remaining 218, thereby causing processor 206 to remove a selected potential decision from the remaining decisions 218 and store the selected decision in a removed decisions data store 222. During a selection phase, instructions 214 may configure the processor to copy selected decisions from decisions remaining 218 to a selected sets data store 220, which may store each users respective selected subsets, e.g., sₙ described above. When each user has completed selecting their respective subset of potential decisions, instructions for generating a decision basis may then be loaded thereby causing the processor 206 to generate and store a decision basis 224 by generating, or determining, an intersection between each users' respective selected subset from the selected sets data store 220. System 200 may be configured to store each data set 218, 220, 218 to persistent storage in non-transitory memory 204 as necessary to preserve the decision making process during the span of time over which the process unfolds or for posterity. Furthermore, system 200 may have other ancillary functionality as one may expect from modern computer programs, such as a user profile containing login information and user information, allowing a user to log into a unique profile and view information tailored to them, such as their own respective selected subset of favorites from selected sets 220.

One will further appreciate that user interface 208 and IO 210 may be operatively coupled to processor 206 via a hardwired connection, e.g, coupled via cabling or wires to processor 206 as a standalone laptop or desktop or smart device, but alternatively, user interface 208 and IO 210 may be separated from processor 206 by a great distance by being operatively coupled to processor 206 via a network, that may include a combination of wire network and wireless network. For example, user interface 208 and IO 210 may be components of a smart device, such as a tablet computer, that is used on the home of a decision maker and is itself coupled to an in home wifi connection, which is then coupled to the Internet, thereby coupling to processor 206, which may be remote from user interface 208 and IO 210. In such case processor 206 may be a server that processes many instances of software to facilitate decision making in accordance with this disclosure. In such a case, a user may log into their user profile and access a particular instance of software that is unique to a user's decision making together with another decisions maker. Meanwhile processor 206 is similarly hosting other instances of decision making processes on behalf of many other users accessing their own unique instances in a client server type architecture. In embodiments a user interface is an application, for example downloaded from Google Play or the App Store and installed on a user's mobile device, and which cooperates with a server hosted instance of decision making software for performing methods in accordance with this disclosure.

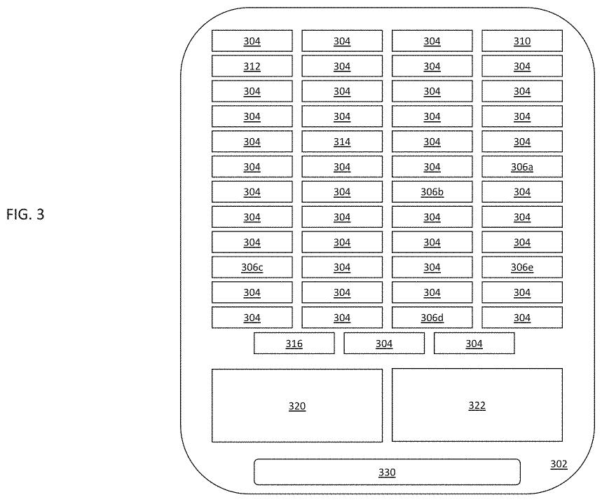

FIGS. 3-7 illustrates aspects of a display 302 for facilitating process 100 or that may be displayed to a user of system 200 via user interface 208. Alternatively display 302 may be in the form of a hangable board game like device that is intended to be prominently displayed where decision makers will regularly see display 302 during time span T so that users may at least periodically consider the remaining decisions, e.g, 304, 306, 308, 310, 312, 314, 316, which may be fastened to display 302 as illustrated in FIG. 3. If a physical tangible board (as opposed to a computer display, e.g., 208) remaining decisions may be fasted to board 302 by any suitable means. In some preferred embodiments, board 302 may include a metallic backing such that magnetic fasteners may be used. Alternatively, board 302 may be formed to include a magnetic material, such that metallic fasteners may be used. In embodiments, decisions are printed or written on cards which are fasted to board 302 using such suitable fasteners. In alternative embodiments, decision cards are themselves magnetic for fastening to board 302. Alternatively, decisions may be simply penned onto predetermined spaces on board 302. Alternatively, board 302 may be a pinboard, such that decision cards may be pinned with thumb tacks or the like.

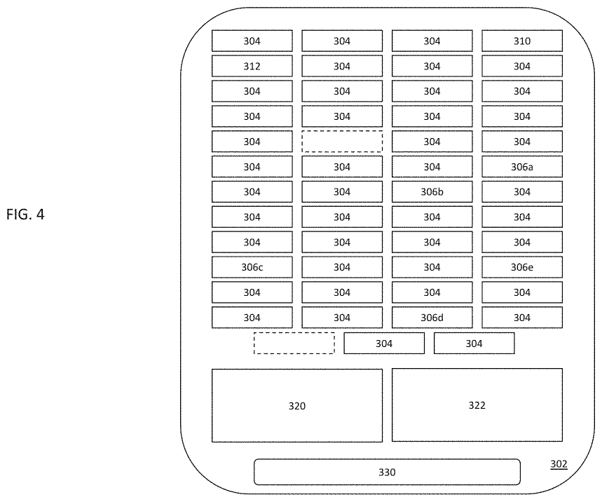

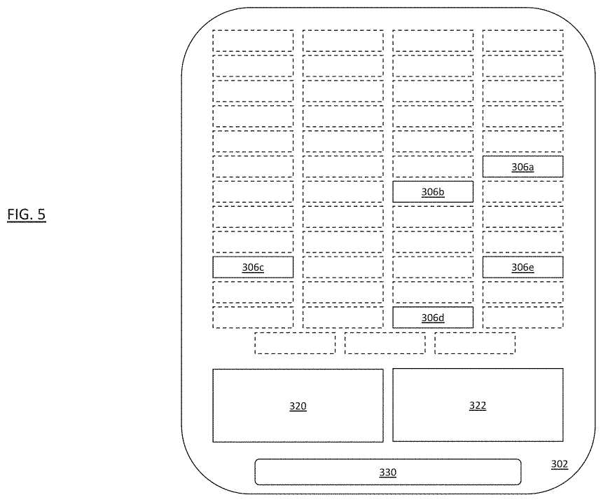

During the course of time span T, in a first period p during a culling phase, e.g., 104, in some exemplary embodiments, a first decision maker may remove a first potential decision 314 and during a second period a second decision maker may remove a second potential decision 316 as illustrated in FIG. 4, showing removed potential decisions. This process continues as shown in FIGS. 5 and 6 until only a remaining set, e.g, S, of potential decisions 306a-e remains when time span T expires. From this subset S comprising potential decisions 306a-e, each decision maker (here two decisions makers) selects a subset of three of the five remaining decisions. For example, a first decision maker moves or copies potential decisions 306a, 306c and 306d into a container 320 for containing a first subset, e.g., s1 as shown in FIG. 6. Subsequently or at the same time, a second decision maker also moves or copies potential decisions into container 322; in the illustrated example, potential decisions 306a, 306b, and 306e are selected and moved or copied into container 322. In the case where display 302 is a computer program display, this may be accomplished by rendering the movement of a decision into container 320 or 322, as illustrated in FIG. 6 showing decision 306a being selected and dragged into container 320. In the case of a display board, users may instead copy a decision onto a separate decision card and place that decision card into container 320 or 322 as the case may be.

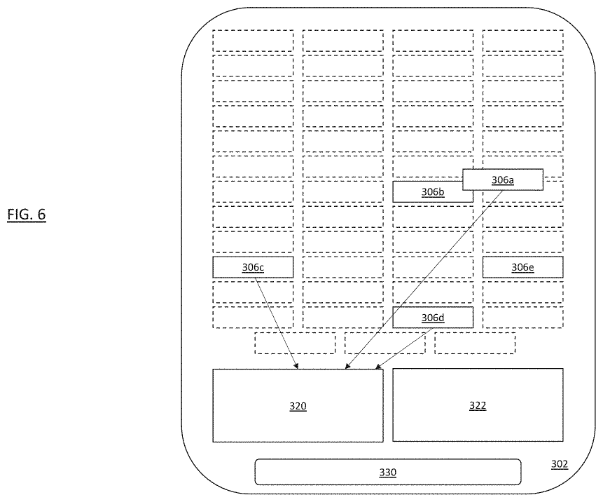

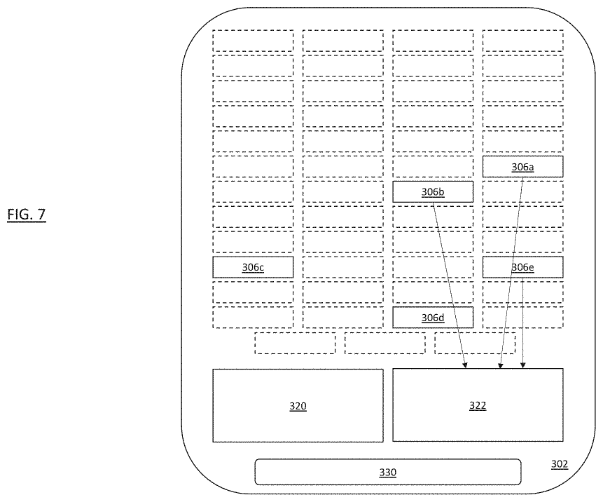

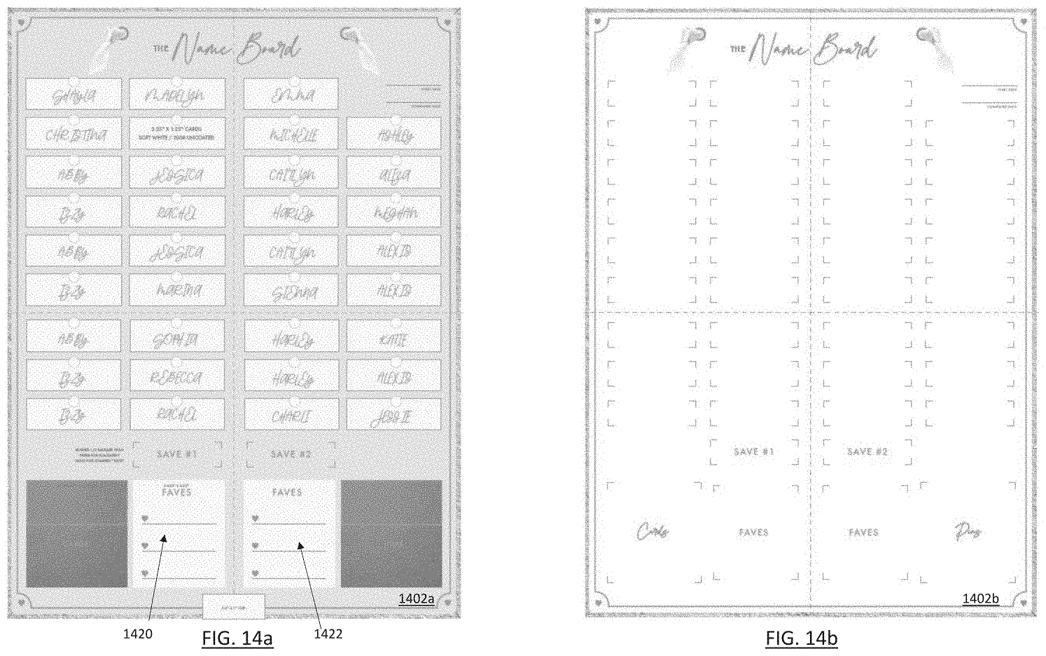

As shown in FIGS. 7 and 8, containers 320 and 322 may optionally obscure each decision makers subsets during each respective decision making process, alternatively, as illustrated in FIG. 14, a user's selected subsets, e.g., selected faves 1420, 1422, may be displayed openly. Also illustrated in FIGS. 7 and 8, in an optional variation, each user may respectively selected one previously removed potential decision and return it to the set S of remaining decisions. For example, in the illustrated embodiment, a first decision maker rescued potential decision 310, while a second decision maker rescued potential decision 312. In the illustrated example, even though a first user did not rescue decision 312, and presumably was the decision maker who originally negated potential decision 312, over the course of the span of time, the first decision maker's underlying rationale has shifted, and through reconsideration first decision maker selects 312 as a member of first decision maker's selected subset, e.g., s₁. Because second decision maker rescued 312, second decision maker also selects potential decision 312 as party of second decision maker's selected subset, e.g, s2.

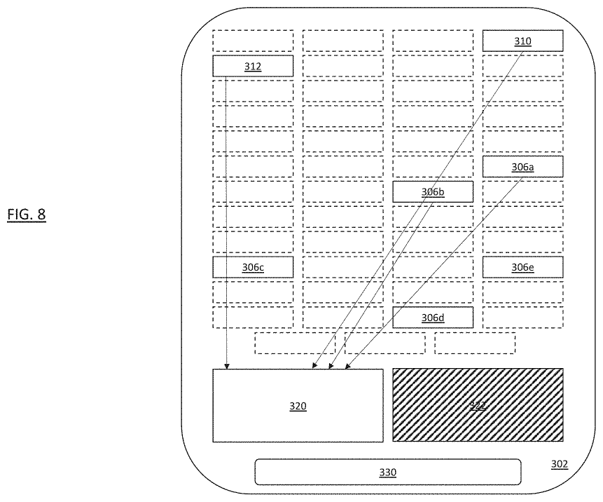

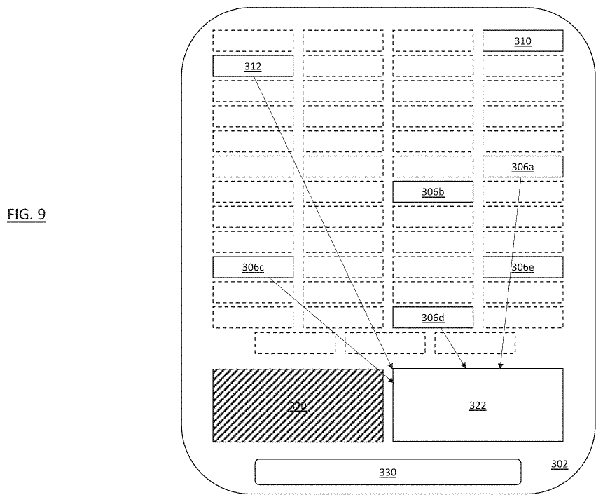

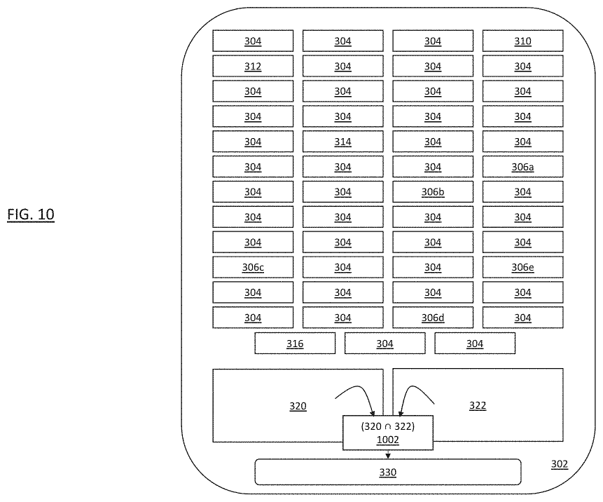

FIG. 10 illustrates the decision basis generation phase, e.g., 108, in which the intersection of sets 320 and 322 is determined or generated, and a decision basis 330 is displayed containing the intersection of sets 320 and 322 (e.g., s₁ and s₂). For example, in the embodiment illustrated in FIGS. 6 and 7, the displayed decision basis 330 includes decision 306a. In another example, in the embodiment illustrated in FIGS. 8 and 9, the displayed decision basis 330 includes decisions 306a and 312.

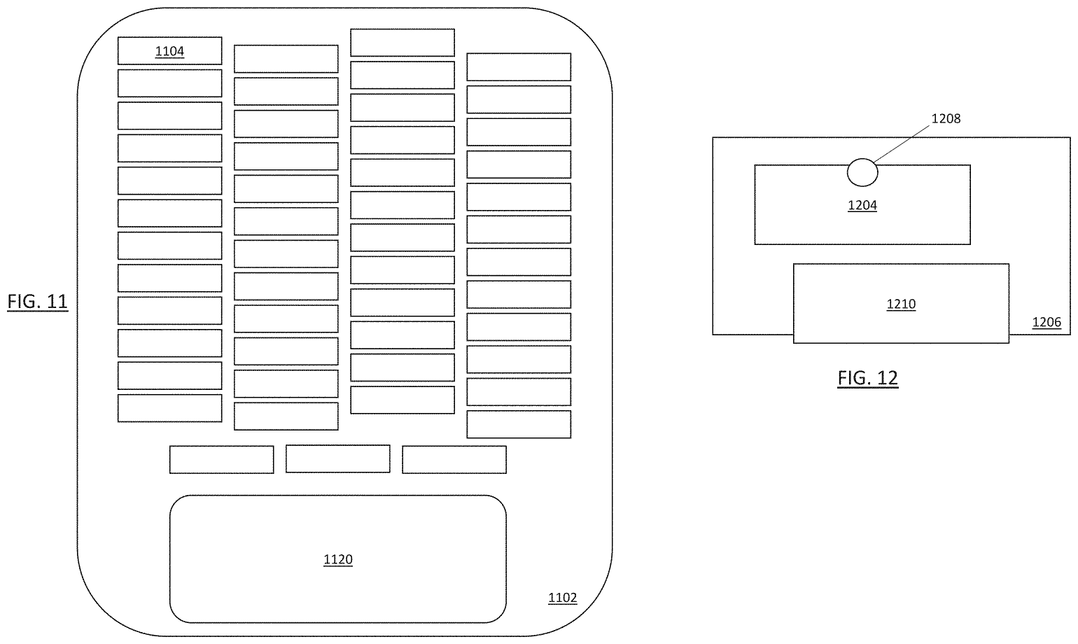

FIG. 11 illustrates another exemplary embodiment of a display 1102 in which potential decisions 1104 are displayed in a staggered fashion. It will be appreciated that a display such as 302 or 1102 may be of any suitable design that allows users to easily view the set of remaining potential decisions. In the exemplary embodiment of FIG. 11, display 1102 is a computer generated display that includes a status window 1120 that may provide users a variety of information, such as the amount of time remaining in the time span, a list of removed names, and each users rescued decisions or selected sets, and ultimately the decision basis, among other things as may be useful or entertaining for users to view.

FIG. 12 illustrates on aspect of a display board 1206, omitting redundant features. FIG. 12 in particular illustrates a decision card 1204 fastened to a tangible display board 1206 using a fastener 1206, which may be any suitable fastener as described above. For example, fastener 1208 may be a magnetic button. Board 1206 may further including an attached cup or other container for holding magnetic buttons as decision cards, e.g., 1204, are removed.

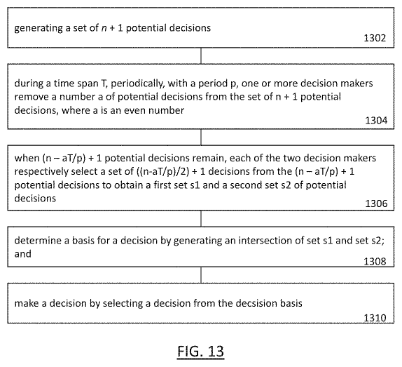

FIG. 13 illustrates another exemplary method in accordance with this disclosure by way of a flow chart. In a first step 1302, a set of n+1 potential decisions are generated or otherwise obtained. In a second step 1304, during a time span T, periodically, with a period p, two decision makers remove a number a of potential decisions from the set of n+1 potential decisions, where a is an even number. When (n−aT/p)+1 decision remain, in step 1306, each of the two decision makers respectively select a set of ((n−aT/p)/2)+1 decisions to obtain a first subset s₁ and a second subset s₂ of potential decisions. In step 1308, a basis for a decision is generated by determining an intersection of sets s₁ and s₂. Lastly, a decision is made in step 1310 by selecting the decision from the decision basis.

Insofar as presenting the display over a span of time T is critical to the decision making techniques described in this disclosure, design of the display, e.g., 302, 1102, 1206, or 1402 is critical and thus the display should be configured to maximize decision maker participation. If a decision maker is a human, a display may be a computer display or a board, such as a game board. Exemplary embodiments of a display are illustrated in the attached FIGS. 3-12 and 14. In each case, the embodiment shown may be a physical game board embodiment, or they may alternatively be a computer based display, for example an app display. If, however, decision makers include one or more autonomous computer algorithms, a display may be a data structure configured to interface with such an autonomous computer algorithm through an API such that no board is necessary.

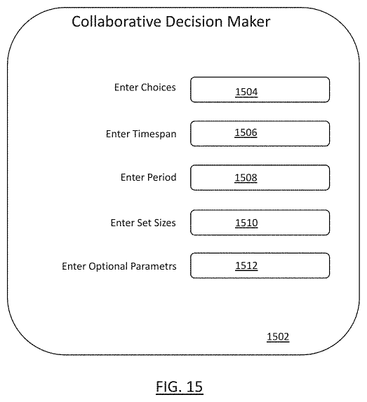

In one embodiment, illustrated in FIG. 15, a computer display 1502 is configured to receive a set of D choices in field 1504, a time span Tin field 1506, a period p in field 1508, a remaining set S size in field 1510, and optional parameters (e.g., introduce optional saves, introduce random decision making, introduce an additional random removal) in field 1512. Based on the information entered into this computer display, a decision making display, e.g., as shown in FIGS. 3-11, may be created. In embodiments, the created display is a computer display. In embodiments, a periodic alert is created at the end of each period p requiring a user to exercise their removal power. For example, an alert may be a text message, an email, an alarm. Alternatively, a physical display e.g., 1402, may be displayed in a prominent position that a decision maker is guaranteed to check, for example in one's kitchen, living room, entryway, or bedroom. By altering decision making towards a convergence, a consensus decision may be achieved that is acceptable to each party. In an alternative embodiment, information retrieved from a computer screen display such as that shown in FIG. 15 may be received via a computer and fed to a manufacturing process where it s₁ used to generate a physically desirable display and attendant components such as that illustrated in FIG. 14.

In embodiments of a physical display for human decision makers, a high physical aesthetic is desirable to maximize attention and consideration given to a display during each period.

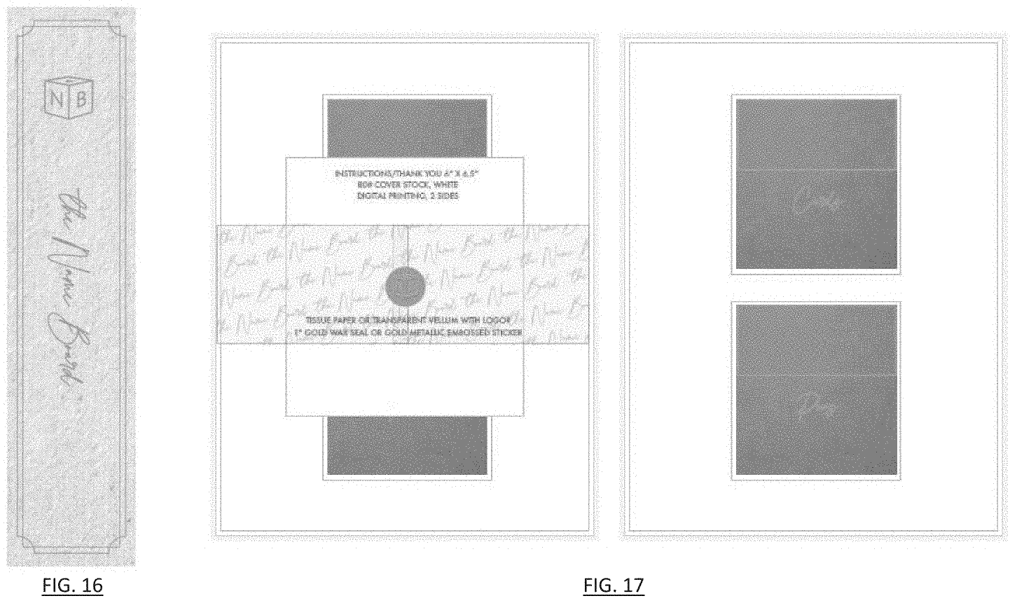

In one exemplary embodiment, a physical display 1402 is provided in a high aesthetic, as illustrated in FIGS. 14a and 14b showing a foldable board (as indicated by the dotted lines) with components (e.g., name cards, envelopes and containers) attached in FIG. 14a, and prior to attachment in FIG. 14b. A goal of such an exemplary design is to be large enough that it can be casually viewed throughout the day by each decision maker while maintaining the capability to be stored in a protective box when finished. The display may be a board that opens up to a size of 18″×24″ which can be hung or propped up on a table top easel. This aids in the effectiveness of the decision-making process as compared to known decision making processes which allow one to see a decision, e.g., a name, once and are forced to decide immediately. When the process is complete, the board simply folds back into a beautiful, keepsake box as illustrated in FIGS. 16-17.

### Materials for a Physical Display Embodiment

### Name Cards:

There may be 50 (plus a few extra in case of mistakes) heavy-weight blank cards for all proposed names to be written onto. These cards may be attached to the board by various means: (1) sticky backs, simply removing a back covering to reveal a sticky side and attach it directly to a designated area which will be clearly outlined on a board; (2) sliding a card into small slits in a display board itself; (3) pushpins or thumbtacks; (4) magnetic buttons; (5) magnetic cards, or the like. One will appreciate any suitable fastener will suffice depending on the chosen aesthetic.

### The Board:

The display may be a board that may be an 18″×24″ foldable board made of chipboard, similar to that of a traditional game board, however overlaying material will provide a more appealing high quality textured material. Design of a board will vary, depending on a theme of the set, i.e. baby girl, baby boy, unisex, animal, business. In a case of option 1 for name cards, there will be some form of organizational system printed on a board so a user knows exactly where to place each name card. If option two, there may be subtle, yet precisely placed slits on a display main board that will allow for loose name cards to be attached in a clean, organized fashion.

### Pen:

A felt tip marker may be provided in the set which can be used to write the cards on blank cards provided. Optionally, cards may be pre-printed in high quality.

Exemplary instructions for a game board version in accordance with this disclosure follow here. These instructions are intended to accompany the components discussed above:

˜The Name Board INSTRUCTIONS˜

Hello! Congratulations on the anticipated arrival of the newest member of your family! We are so thankful to be part of this special time in your life when you get to choose the “forever” name your child will come to know. I hope The Name Board can help make this important process fun, effortless, and a memorable experience for years to come!
TO START: Scour the internet for the best baby names you can find. Try to come up with 50 names that are interesting or intrigue you in some way. They don't have you to be your “favorite” . . . YET! Try to keep an open mind & don't rush to any definitive decisions quite yet. Fill in the names at the top of your board.
HOW IO PLAY: Now that you've filled out cards with all your favorite names, the fun can begin! Once a day, you and your partner are to cross off one name each. You should always eliminate your LEAST favorite name that remains on the board. If you start with 50 names, this method should take you just over 3 weeks to complete. If you couldn't come up with 50 that's okay; you will just complete your game sooner. To prolong the suspense, you can double the game time by alternating days of who gets to cross off their one name.
STOP CROSSING OFF NAMES when you have six names left on the board. (If you can only get to 8 that's okay too!) When you get to this point, each you and your partner get to “SAVE” one name that your partner crossed off (or that you regretfully eliminated) earlier in the game and fill it in the blank marked with the STAR.
THE MOMENT OF TRUTH!! . . . . If you have completed all the steps above, you should have 8 names left on your board. Each you and your partner should remove the square from the bottom of the board and SEPARATELY write down your FAVORITE 3 NAMES of the 8 left on the board. Don't PEEK! Once you have each decided on your top 3 names, share your lists! Do any of your names match?! If they do, CELEBRATE because you have successfully agreed on your favorite name TOGETHER! If more than one name match, then celebrate the similar taste you and your partner share! Could one be considered for a middle name? Congratulations on your beautiful new bundle of j oy that now has a NAME he will be proud of the rest of his life! IF NON OF YOUR NAMES MATCH, don't panic! You still have successfully narrowed your choice down to six! Try placing these names somewhere you will see them daily & try to be open to your partners favorites. After a few days, try again. This time, separately write down your favorite two names of the six remaining on your squares. Choosing a name for your precious child is a great responsibility and should be something both of you can be proud of. It may take some compromise but in the end, no matter what name you decide on, you can be sure you will both love that child completely. And THAT is something you can agree on.

In embodiments, when a high quality luxury version is created, a foldable board, and attendant components, may be sent to a decision maker in a high quality personalized box set as illustrated in FIGS. 16-17, showing a spine of the box set, FIG. 16, and an illustration of the opened box set, FIG. 17. In embodiments, the personalized box sets may be stackable so that documentation of multiple decisions, e.g., multiple baby names for a set of siblings, may be stored together conveniently.

I claim:

1. A method for facilitating collaborative decision making between two decision makers, comprising:
selecting a set of fifty-one potential decisions;
over a period of forty-six days, each day one of the two decision makers negates a potential decision from the set of fifty-one potential decisions in an alternating fashion such each decision maker respectively negates a respective one decision every other day until a set of five remaining decisions remain of the set of fifty-one potential decisions;
when the set of five remaining decisions remain, in secret, each of the two decision makers selects a set of three decisions from the set of five remaining decisions guaranteeing that at least one remaining decision of the five remaining decisions will be selected in each set of three decisions;
each decision maker reveals their respective set of three decisions; and
generate an intersection of the sets of three decisions to form a basis for a decision, wherein the intersection is the basis for the decision.

2. The method of claim 1, wherein upon selecting the set of fifty-one potential decisions, the set of fifty-one potential decisions are removably attached to a display board.

3. The method of claim 2, wherein when one of the two decision makers negates a potential decision from the set of fifty-one potential decisions the one of the two decision makers removes the decision from the display board.

4. The method of claim 3, further comprising, on a forty-seventh day, each of the two decision makers negates a potential decision from the remaining potential decisions of the set of fifty-one potential decisions; and
each of the two decision makers selects a previously negated decision and returns it to the board as an additional remaining potential decision to form the set of five remaining decisions.

5. The method of claim 1, wherein the fifty-one potential decisions are one of potential baby names, potential pet names, potential investments, potential hires, or potential travel destinations.

6. The method of claim 1, wherein each of the two decision makers selects one of the negated potential decisions and adds the selected on of the negated potential decisions to the set of five remaining decisions to create a set of seven remaining decisions and each decision maker adds a fourth selected decision to their respective set of three decisions to form a respective set of four decisions, wherein the intersection of each respective set of four decisions is the basis for the decision.

7. A method for facilitating collaborative decision making between two decision makers comprising:
a. generating a set of n+1 potential decisions, where n is an even number;
b. during a time span T, periodically, with a period p, remove a number a of potential decisions from the set of n+1 potential decisions, where a is an even number;
c. when (n−aT/p)+1 potential decisions remain, each of the two decision makers selects a set of ((n−aT/p)/2)+1 decisions to obtain a first set s₁ and a second set s₂ of potential decisions;
d. determine a basis for a decision by generating an intersection of set s₁ and set s₂; and
e. make a decision by selecting the decision from the basis.

8. The method of claim 7, wherein the period p is one day.

9. The method of claim 7, wherein the period p is two days.

10. The method of claim 7, wherein the period is a number x of days and the time span T is equal to x*p days.

11. The method of claim 7, wherein during each period one of the two decision makers selects a decisions.

12. The method of claim 7, wherein during each period each of the two decision makers respectively selects a/2 decisions.

13. The method of claim 7, wherein n=50, p=2 days, a=2, T=46 days.

14. The method of claim 13, wherein each p/2 days one of the two decision makers removes a/2 decisions in an alternating fashion.

15. The method of claim 8, wherein n=40, p=1 day, a=4, T=9, and each period each respective decision maker removes a/2 decisions from the set of n+1 decisions.

16. An apparatus for facilitating collaborative decision making between two decision makers, comprising:
a. one or more computer processors; and
b. one or more memories operatively coupled to at least one of the one or more processors and having instructions stored thereon that, when executed by at least one of the one or more processors to:
i. generating a set of n+1 potential decisions, where n is an even number;
ii. during a time span T, periodically, with a period p, based on input from one of the two decision makers via a computer user interface, remove a number a of potential decisions from the set of n+1 potential decisions, where a is an even number;
iii. when (n−aT/p)+1 potential decisions remain, each of the two decision makers selects via the computer user interface a set of ((n−aT/p)/2)+1 decisions from the (n−aT/p)+1 potential decisions to obtain a first set s₁ and a second set Ω of potential decisions;
iv. determine a basis for a decision by generating an intersection of set s₁ and set s₂; and
v. make a decision by selecting, based on input received via the computer user interface, the decision from the basis.

17. The apparatus of claim 16, wherein the computer user interface is a component of a mobile processing device, and the at least one of the one or more computer processors is located remotely from the mobile processing device and the at least one of the one or more computer processors communicates via at least a wireless communications channel with the mobile processing device.

18. The apparatus of claim 17, wherein the computer user interface is a combination of mouse, keyboard, and computer display or wherein the computer user interface is a touch screen.

19. The apparatus of claim 17, wherein the set of n+1 potential decisions are selected at random from a catalog of potential decisions.

20. The apparatus of claim 16, wherein when each of the two decision makers selects, via the computer user interface, the set of ((n−aT/p)/2)+1 decisions, the other respective one of the two decision makers selected set of ((n−aT/p)/2)+1 decisions is either kept secret or is obscured.
